(19) United States
(12) Patent Application Publication
(10) Pub. No.: US 2016/0001831 A1
(43) Pub. Date: Jan. 7, 2016

(54) Multi-Legged Running Robot

(71) Applicants: Sebastien Cotton, Pensacola, FL (US); Johnny C. Godowski, Pensacola, FL (US); Nicholas R. Payton, Pensacola, FL (US); Micael Vignati, Pensacola, FL (US); lonut Olaru, Pensacola, FL (US); Christopher Schmidt-Wetekam, Pensacola, FL (US); Colton Black, Pensacola, FL (US)

(72) Inventors: Sebastien Cotton, Pensacola, FL (US); Johnny C. Godowski, Pensacola, FL (US); Nicholas R. Payton, Pensacola, FL (US); Micael Vignati, Pensacola, FL (US); lonut Olaru, Pensacola, FL (US); Christopher Schmidt-Wetekam, Pensacola, FL (US); Colton Black, Pensacola, FL (US)

(21) Appl. No.: 14/596,514

(22) Filed: Jan. 14, 2015

Related U.S. Application Data
(60) Provisional application No. 61/921,300, filed on Dec. 27, 2013.

(51) Int. Cl. B62D 57/02

(52) U.S. Cl. CPC B62D 57/022; Y10S 901/01

(57) ABSTRACT

A robotic system capable of traveling at high speeds using two sets of rotating legs. The system does not need to contain sensors, a controller, or feedback technology. There are at preferably two parameters controlled—the acceleration via throttle and turning via tilt of the main body of the system. A set of at least one rotating leg sits on either side of the system. The center of mass of the system is below the main axis in order to keep the system stable without use of a control system.

### CROSS-REFERENCES TO RELATED APPLICATIONS

This non-provisional patent application claims the benefit of an earlier-filed provisional application pursuant to 37 C.P.R. section 1.53(c). The provisional application listed the same inventors and was assigned Ser. No. 61/921,300.

### STATEMENT REGARDING FEDERALLY SPONSORED RESEARCH OR DEVELOPMENT

Not Applicable

### MICROFICHE APPENDIX

Not Applicable

### BACKGROUND OF THE INVENTION

1. Field of the Invention

The invention relates to the field of robotic runners. More specifically, the invention comprises two rotating leg assemblies connected to a central body of a robot that is capable of running.

2. Description of Related Art

The application of robots and robotic machines has been used in many ways. This application varies from performing a task too tedious for a human or requiring such precision that a machine does the task more quickly and accurately. Recently, the focus of much of the research involving robotics has altered to different applications. Researchers have been developing robots that imitate the motion of living organisms. The technology includes robots that walk, climb, crawl, swim, and run.

Many biological systems and mechanics can be accurately modeled using simple mathematical or mechanical models. Because of this, the motion of living organisms has been replicated with surprising accuracy. The benefit of mimicking living creatures stems from the agility and adaptability of living organisms, for example, the wheels required to traverse grass are different from the wheels required to traverse concrete. While each set of wheels may work for both sets of environments, the efficiency may be reduced depending on the intended design. However, the legs of a larger animal traverse both environments with relatively equal efficiency. Thus, a robot with legs will have similar efficiency while traversing multiple environments.

Oftentimes using an active system will increase the stability of a robotic system. At times, this can actually be the only method to introduce any stability to the system. Typically, an active system requires expensive sensors and programming that sends corrective feedback to the control system integrated into the robot. This varies greatly from system to system. An example of a simple model of an active system is a tightrope walker. As the user reels himself or herself start to lean one way (sensors), he or she raises the opposite arm (control system) to prevent from falling. While this method can be advantageous, the sensors, controllers, and programming are expensive. In addition, these measures require space, add weight, increase electrical consumption, and increase complexity to the system. Thus, it is desired to achieve similar stability without these active control measures, if possible.

There are robotic systems that do not contain feedback and control systems. Typically, these systems comprise a slow moving (walking or crawling) robot with very little environmental disruption.

Therefore, what is needed is a lightweight, passively stable robot capable of traversing quickly over multiple terrains. The present invention achieves these objectives, as well as others, which are explained in the following description.

### BRIEF SUMMARY OF THE INVENTION

The present invention comprises a robotic system capable of traveling at high speeds using a set of rotating legs connected together. The invention may be operated without sensors, a controller, or feedback technology—though some embodiments optionally may include these features. The invention may he operated using only two controlled parameters—acceleration via the throttle setting and turning via the tilt of the main body of the system.

Each set of rotating legs contains at least, one leg and preferably two or more legs. The equivalent of a bipedal gait is established based on the rotation, compression, and spacing of the legs. The center of mass of the system is preferably low enough to die ground to keep the system stable without use of a control system. Applying torque between the center of mass and the hub allows for power and steering.

### BRIEF DESCRIPTION OF THE SEVERAL VIEWS OF THE DRAWINGS

FIG. 1 is a perspective view, showing a preferred embodiment of the present invention.

FIG. 2 is an elevation view, showing a preferred leg assembly.

FIG. 3 is an elevation view, showing the effect of the leg of the current invention impacting the ground.

FIG. 4 is and elevation view, showing the turning mechanism of the present invention.

### REFERENCE NUMERALS IN THE DRAWINGS

| | | | |
|---|---|---|---|
| 10 | multi-legged running robot | 12 | main body |
| 14 | lower body | 16 | leg assembly |
| 18 | linking tab | 20 | leg |
| 22 | leg guide | 24 | leg mount |
| 26 | leg cap | 28 | foot |
| 30 | leg catch | 32 | rubber band |
| 34 | peg | 36 | axle |
| 38 | surface | 40 | large gear |
| 42 | stationary gear | 44 | shaft |

### DETAILED DESCRIPTION OF THE INVENTION

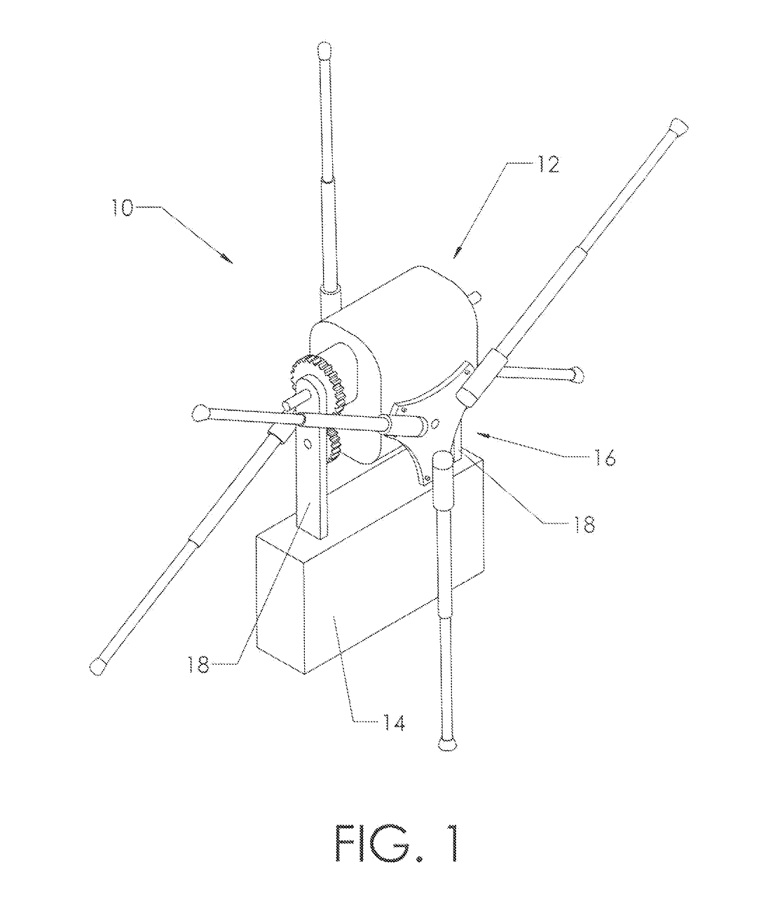

The present invention provides a robotic system capable of traveling at various speeds using rotating legs. The robot is capable of “running” at high speeds. FIG. 1 shows a preferred embodiment. Multi-legged running robot 10 includes main body 12, lower body 14, and two leg assemblies 16. Preferably, main body 12 includes at least two motors. One motor is required to rotate leg assembly 16. This motor controls the acceleration of multi-legged running robot 10 by providing torque to leg assembly 16 by means of a rotating shaft. The second motor allows the user to steer running robot 10. This is discussed further in the subsequent text. In a preferred embodiment of the present invention, the only means of control for multi-legged running robot 10 are the throttle (acceleration) and the steering. Preferably, these control means are provided using a remote control, though a larger version could accommodate a human operator or automated control system on board.

Linking tab 18 connects main body 12 to lower body 14. Lower body 14 is capable of housing necessary components, such as wiring, battery packs, or any other necessary components required for running robot 10 to operate. In addition, it is preferred than lower body 14 includes a balance weight (though a battery may serve this purpose adequately). In order to keep multi-legged running robot 10 stable, the majority of the weight of robot 10 is preferably located below the axis of rotation of leg assembly 16. This keeps the center of mass of the system relatively low and below the axis of rotation, if the center of mass is too high, robot 10 would be unbalanced and fall easily.

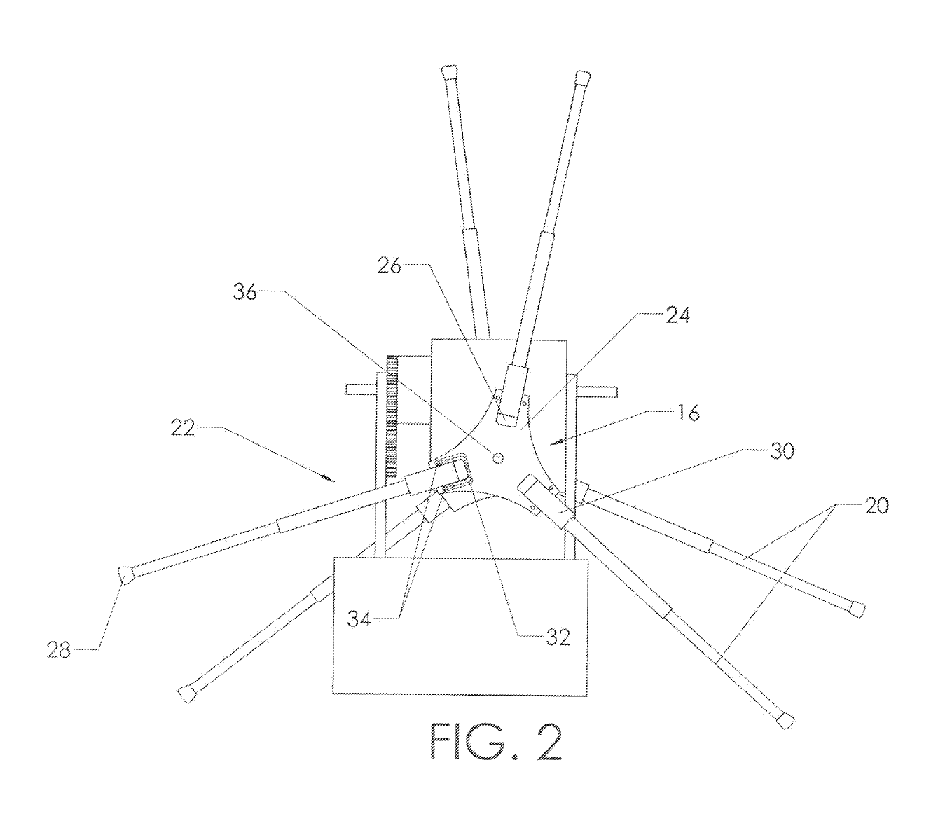

An important detail that contributes to the ability of robot 10 to travel at high speeds is the configuration of legs 20. FIG. 2 shows a preferred method of attaching legs 20. Leg guide 22 is rigidly attached to leg mount 24. Leg 20 is mated concentrically with leg guide 22. Leg 20 is capable of translating axially along leg guide 22. Leg 20 has a first end and a second end. The first end is attached to leg cap 26. The first end is proximate the body of robot 10. The second end is attached to foot 28. Foot 28 impacts the surface that multi-legged running robot 10 runs upon. Leg guide 22 includes leg catch 30, which engage leg cap 26 in a manner that prevents leg 20 from sliding out of leg assembly 16. This is an example of a travel limiting device that limits the extension of the foot away from the axle.

Rubber band 32 is an example of a bias device configured to urge the foot of a leg away from the axle. It restricts leg 20 in the opposite direction as leg catch 30. Rubber band 32 is wrapped around two pegs 34. As shown in the figure, each end of rubber band 32 is wrapped around separate pegs 34, then stretched over leg cap 34. While there is no force on foot end 28 of leg 20, the force created by stretched rubber band 32 keeps leg cap 26 firmly engaged to leg catch 30. However, when a force is applied to foot end 28 of leg 20, rubber band 32 is stretched further, allowing leg 20 to translate towards axle 36.

Rubber band 32 is one example among many possibilities of bias devices. One could also use a cod spring, a leaf spring, a compression block, or an air spring. One could also add a dampener operating in concert with the bias device. Likewise, the interaction between the leg catch and leg cap is only one example of a travel limiting device. There are many different mechanisms that could be used to limit the extension of the leg, in fact, some devices can function as both bias devices and travel-limiting devices. An example is a coil spring secured at both ends. The coil spring could limit extension while acting in tension and limit compression while acting in compression.

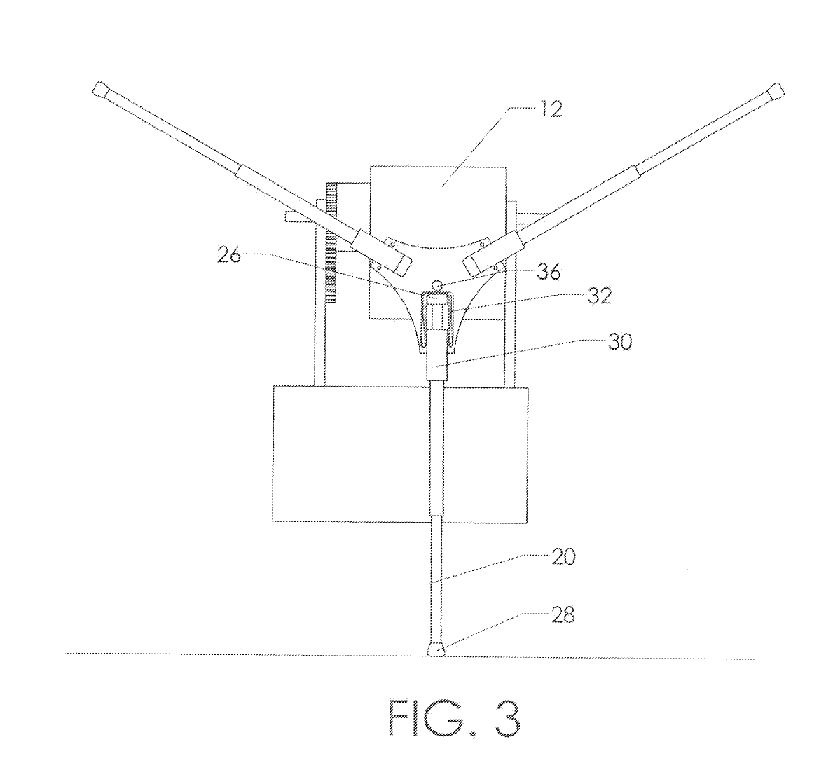

FIG. 3 shows the effect of a force acting on foot end 28 of leg 20. The reaction force created by foot 28 impacting surface 38 causes leg 20 to translate within leg guide 22. This causes leg cap 26 to disengage from leg catch 30, thereby stretching rubber band 32. Once the force created by the interaction between the weight of running robot 10 and surface 38 is removed, (i.e. leg assembly 16 continues to rotate) the resistance created by stretching rubber band 32 returns leg cap 26 to engage leg catch 30. This interaction is important for two reasons. First, the dampening effect of the rubber band/piston system increases the stability of the system, as demonstrated in the running mechanics of mammals. The method of locomotion is achieved by either a rotating or reciprocating leg assembly. The angle at which foot 28 impacts surface 38 is preferably high, imparting stability. Thus, the relatively heavy weight of main body 12 and lower body 14 and the dampening created by the piston/rubber band system allow the system to easily travel smoothly forward and remain stable. The reader will note that, although surface 38 is depicted as a horizontal surface, running robot 10 is capable of running on a varying surfaces. Terrain robot 10 is capable of traversing includes grass, concrete, inclined and declined surfaces, rocky terrain, and other surfaces.

Although FIG. 3 shows a rubber band used as the dampening agent, there are other possible embodiments. For example, a compression spring could be used with the same effect as the rubber hand—using stored energy to dampen and restore the legs of the running robot. Thus, the reader should not limit the scope of the invention to the rubber band and piston configuration illustrated, but rather to any means of dampening/compression available in the art.

As discussed in the preceding text, multi-legged running robot 10 includes main body 12. Main body 12 preferably includes a motor or motors that are attached to axle 36. As the motor turns axle 36, leg assembly 16 rotates. Robot 10 includes two leg assemblies 16. In a preferred embodiment (shown), each leg assembly 16 contains 3 legs 20. In order to imitate a bipedal gait, leg assemblies 16 are 60 degrees out of phase. This is demonstrated in FIG. 1 (FIG. 3 has only one leg assembly to focus on rubber band 34). Although three legs are shown for each leg assembly, the reader will note that the running leg robot will still function with more or less legs attached to each assembly. Those skilled in the art will recognize that the motor described controls the acceleration of the robot, and therefore the speed. Preferably, this is accomplished using a remote control.

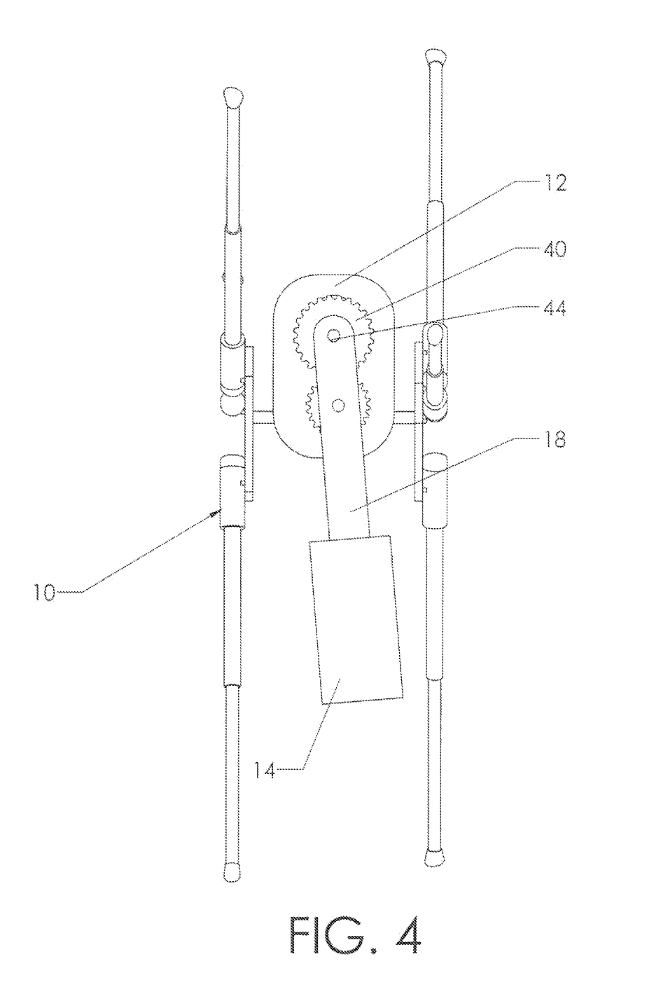

FIG. 4 demonstrates an embodiment of a second form of control preferably included in multi-legged running robot 10. It is desirable to laterally offset the robot's center of mass in order to steer the robot while the robot is in motion. In the embodiment of FIG. 4, main body 12 contains a second motor. This motor rotates large gear 40. Stationary gear 42 is rigidly fixed to linking tab 18. Stationary gear 42 is not capable of rotation. Linking tab 18, however, is free to rotate on shaft 44. The restraints presented result in rotation of linking tab 18 and therefore lower body 14 when large gear 40 is rotated, in this embodiment significant weight is (relatively) contained within lower body 14. The lateral offset of the center of mass resulting from tilting the lower body causes running robot 10 to lean (and turn). Robot 10 turns in the direction lower body 14 leans. In a preferred embodiment of the present invention, the motor rotating large gear 40 is also controlled using a remote control. First and second motor include drive trains that connect the motors to the upper body. However, many other arrangements can be provided and the invention should not be limited in this manner.

In addition, it is possible to offset the center of mass using a single main body for the robot. This single main body could be tilted relative to axle 36 in order to laterally shift the center of mass. As yet another embodiment, the entire main body could be shifted laterally along axle 36.

While it is the aim of the current invention to travel quickly on rotating legs without the use of sensors, a controller, or any feedback information, the reader will note that these instruments can fee integrated into the system. However, for those embodiments lacking a stability controller, certain design parameters should be taken into account.

First, the center of mass is preferably low enough to keep the robot stable while running. Second, the system is designed in such a way that the reaction force vectors created by the leg impacting a surface converge at a point just above the center of mass. This contributes to the stability of the system. Finally, the dampening in the legs allows the system to maintain high velocities while remaining stable.

Some general characteristics of the running robot, will apply to differing embodiments using differing numbers of legs. The robot mimics a bipedal running gait. Returning to FIG. 1, the reader will recall that the robot includes two set of legs. The leg assembly nearer the user in the view includes 3 legs and the leg assembly further away also includes 3 legs. The legs in each assembly are angularly spaced around a 360 degree circle—with the angular spacing between each pair of legs being equal. For a three-legged assembly (as shown), this fact means that the 360 degree circle must be divided by 3 so that the result is 120 degrees of angular spacing between each pair of legs.

There must also be an angular phase difference in the rotation of the two leg assemblies. The phase difference is preferably 4 the angular spacing between the legs in a leg assembly. In the embodiment of FIG. 1, the phase displacement is 60 degrees. The reader will observe that the leg assembly further away from the viewer in FIG. 1 is 60 degrees out-of-phase with the leg assembly nearer the viewer.

A driving motor or motors are provided to rotate the leg assemblies relative to main body 12. From the vantage point of FIG. 1, both leg assemblies would be rotated counterclockwise to move the robot to the left. Both leg assemblies would be rotated clockwise to move the robot to the right. The phase-difference between the leg assemblies is significant to the objective of mimicking a bipedal gait.

FIG. 1 may be considered a frozen “snapshot” of the robot in a running state. In this explanation the robot is running to the left. The two leg assemblies 16 are being driven rapidly in the counterclockwise direction. One leg in the nearer leg assembly is in contact with the ground and the foot of that leg is both supporting the weight of the robot and thrusting the robot along. Meanwhile, the left-most leg of the other leg assembly is rotating down so that its foot is about to contact the ground and begin its support/thrust stroke as the foot of the leg presently on the ground rotates out of contact with the ground. In this embodiment only two legs are interacting with the ground at any given time.

An embodiment using four legs in each leg assembly is possible. For such an embodiment the angular spacing between neighboring legs would be 360/4, or 90 degrees. The phase difference between the two leg assemblies would be 90/2, or 45 degrees. Embodiments with two legs per assembly are possible, as are embodiments with five or more legs per assembly.

Other variations which may be present in the preferred embodiments include:

1. Separate driving motors for the two leg assemblies so than the speed of rotation and phase-difference can be altered;

2. Orientation sensors to assist in actively controlling the robot; and

3. Position sensors to assist in actively controlling the robot.

The preceding description contains significant detail regarding the novel aspects of the present invention. It should not be construed, however, as limiting the scope of the invention but rather as providing illustrations of the preferred embodiments of the invention. Accordingly, the scope of the invention should be determined by reference to the following claims rather than the examples given.

Having described our invention, we claim;

1. A running robot that is able to run over the ground, comprising:
a. a main body having a right side and a left side;
b. a first leg assembly rotatably connected to said right side of said main body at a first axis of rotation;
c. a second leg assembly rotatably connected to said left side of said main body at a second axis of rotation, said second axis of rotation being aligned with said first axis of rotation;
d. wherein said first leg assembly includes,
i. a first plurality of angularly-spaced legs, with a first angular spacing between neighboring legs in said first plurality being the same for all legs,
ii. each of said legs including a foot configured to contact said ground,
iii. each of said feet being movable toward said first axis of rotation,
iv. a bias device configured to urge each of said feet away from said first axis of rotation,
v. a travel limiting device configured to limit the travel of each of said feet away from said first axis of rotation;
e. wherein said second leg assembly includes,
i. a second plurality of angularly-spaced legs, with a second angular spacing between neighboring legs in said second plurality being the same for all legs and being the same as said first radial spacing,
ii. each of said legs including a foot configured to contact said ground,
iii. each of said feet being movable toward said second axis of rotation,
iv. a bias device configured to urge each of said feet away from said second axis of rotation,
v. a travel limiting device configured to limit the travel of each of said feet away from said second axis of rotation;
f. said second leg assembly being rotationally displaced from said first leg assembly about said second axis of rotation by one-half said first angular spacing; and
g. at least one driving motor for rotationally driving said first and second leg assemblies,

2. A running robot as recited in claim 1 wherein said robot has a center of mass and said center of mass is below said first and second axes of rotation

3. A running, robot as recited in claim 1, wherein:
a. said robot has a center of mass; and
b. said robot is configured to laterally displace said center of mass in order to steer said robot.

4. A running robot as recited in claim 2, wherein:
a. said robot has a center of mass; and
b. said robot is configured to laterally displace said center of mass in order to steer said robot.

5. A running robot us recited in churn 1, further comprising:
a. a lower body located below said main body, said lower body pivotally connected to said main body by a third axis of rotation, said third axis of rotation being substantially perpendicular to said first and second axes of rotation; and
b. a pivoting mechanism configured to pivot said lower body about said third axis in order to laterally shift a center of mass of said robot thereby steering said robot.

6. A running robot as recited in claim 1, wherein:
a. said first plurality of legs includes three legs angularly spaced in 120 degree increments; and
b. said second leg assembly is rotationally displaced from said first leg assembly about said second axis of rotation by 60 degrees.

7. A running robot as recited in claim 1, wherein:
a. said bias devices are springs; and
b. said travel limiting devices are mechanical stops.

8. A running robot as recited in claim 2, wherein:
a. each contact point between one of said feet and said ground produces a reaction force vector; and
b. said robot is configured so that said reaction force vectors converge above said center of mass.

9. A running robot as recited in claim 1 wherein:
a. said robot has a center of mass and said center of mass is below said first and second axes of rotation; and
b. said robot is configured to shift said center of mass laterally in order to steer said robot.

10. A running robot as recited in claim 9, wherein said center of mass is shifted laterally by tilting said main body with respect to said first and second axes of rotation.

11. A running robot that is able to run over the ground, comprising:
a. a main body;
b. a first leg assembly rotatably connected to said main body at a first axis of rotation;
c. a second leg assembly rotatably connected to said main body at a second axis of rotation, said second axis of rotation being aligned with said first axis of rotation, and said second leg assembly being offset from said first leg assembly in a direction parallel to said first and second axes of rotation;
d. wherein said first leg assembly includes,
i. a first plurality of angularly-spaced legs, with a first angular spacing between neighboring legs in said first plurality being the same for all legs.
ii, each of said legs including a loot configured to contact said ground,
iii. each of said feet being movable toward said first axis of rotation,
iv. a bias device configured to urge each of said feet away from said first axis of rotation,
e. wherein said second leg assembly includes,
i. a second plurality of angularly-spaced legs, with a second angular spacing between neighboring legs in said second plurality being the same for all legs and being the same as said first radial spacing,
ii. each of said legs including a foot configured to contact said ground,
iii. each of said feet being movable toward said second axis of rotation,
iv. a bias device configured to urge each of said feet away from said second axis of rotation,
f. said second leg assembly being rotationally displaced front said first leg assembly about said second axis of rotation by one-half said first angular spacing; and
g. at least one driving motor for rotationally driving said first and second leg assemblies.

12. A running robot as recited in claim 11 wherein said robot has a center of mass and said center of mass is below said first and second axes of rotation

13. A running robot as recited in claim 11, wherein:
a. said robot has a center of mass; and
b. said robot is configured to laterally displace said center of mass in order to steer said robot.

14. A running robot as recited in claim 12, wherein:
a. said robot has a center of mass; and
b. said robot is configured to laterally displace said center of mass in order to steer said robot.

15. A running robot as recited in claim 11, further comprising:
a. a lower body located below said main body, said lower body pivotally connected to said main body by a third axis of rotation, said third axis of rotation being substantially perpendicular to said first and second axes of rotation; and
b. a pivoting mechanism configured to pivot said lower body about said third axis in order to laterally shift a center of mass of said robot, thereby steering said robot.

16. A running robot as recited in claim 11, wherein:
a. said first plurality of legs includes three legs angularly spaced in 120 degree increments; and
b. said second leg assembly is rotationally displaced from said first leg assembly about said second axis of rotation by 60 degrees.

17. A running robot as recited in claim 1, wherein said bias devices are springs.

18. A running robot as recited in claim 12, wherein:
a. each contact point between one of said feet and said ground produces a reaction force vector; and
b. said robot is configured so that said reaction force vectors converge above said center of mass.

19. A running robot as recited in claim 11 wherein:
a. said robot has a center of mass and said center of mass is below said first and second axes of rotation; and
b. said robot is configured to shift said center of mass laterally in order to steer said robot.

20. A running robot as recited in claim 19, wherein said center of mass is shifted laterally by tilting said main body with respect to said first and second axes of rotation.
